(19) United States
(12) Patent Application Publication
(10) Pub. No.: US 2014/0166125 A1
(43) Pub. Date: Jun. 19, 2014

(54) MELTER WITH TANK SHAKER

(71) Applicant: GRACO MINNESOTA INC., Minnesota, MN (US)

(72) Inventors: Michael J. Sebion, Apple Valley, MN (US); Nicholas D. Long, Broadview Heights, OH (US); Shaun M. Cook, Tampa, FL (US); Mark W. Sheahan, Inver Grove Heights, MN (US); Mark T. Weinberger, Mounds View, MN (US); Mark J. Brudevold, Fridley, MN (US); Joseph E. Tix, Hastings, MN (US); John S. Lihwa, Willowick, OH (US); Douglas B. Farrow, Plymouth, MN (US); Robert J. Lind, Robbinsdale, MN (US); Paul R. Quam, Brooklyn Center, MN (US); Daniel P. Ross, Maplewood, MN (US)

(73) Assignee: GRACO MINNESOTA INC., Minneapolis, MN (US)

(21) Appl. No.: 13/715,573

(22) Filed: Dec. 14, 2012

(51) Int. Cl. F16L 53/00; F24H 9/00

(52) U.S. Cl. CPC F16L 53/001; F24H 9/00
USPC 137/334; 392/441

(57) ABSTRACT

A melter for a melt system includes a tank, a vibration generating device, and a heater. The tank has a wall for containing a hot melt adhesive, and the vibration generating device vibrates the wall. The heater transfers heat to the tank.

### BACKGROUND

Hot melt dispensing systems are typically used in manufacturing assembly lines to automatically disperse an adhesive used in the construction of packaging materials such as boxes, cartons and the like.

Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure. Additionally, the adhesive that does liquefy can cling to the walls along the periphery of the tank and does not drain to the pump as well as would be desired. The clinging of adhesive to the walls increases the likelihood of charring.

### SUMMARY

According to the present invention, a melter for a melt system includes a tank, a vibration generating device, and a heater. The tank has a wall for containing a hot melt adhesive, and the vibration generating device vibrates the wall. The heater transfers heat to the tank.

In another aspect, a hot melt dispensing system includes a hopper, a melter, a vibration generating device, a feed system, and a dispenser. The hopper stores hot melt pellets for use in the system. The melter is capable of heating hot melt pellets into a liquid and defines a tank for containing the hot melt pellets and the liquid. The vibration generating device vibrates the melter. The feed system transports hot melt pellets from the hopper to the melter. The dispenser administers the liquid from the melter.

In another aspect, a method of melting hot melt pellets into a liquid includes delivering hot melt pellets into a tank of a melter, vibrating the tank, and heating the melter to liquefy the pellets into a melt liquid.

### BRIEF DESCRIPTION OF THE DRAWINGS

FIG. 1 is a schematic view of a system for dispensing hot melt adhesive.

FIG. 2A is a side view of a melt system including a melter with a tank and a vibration generating device.

FIG. 2B is an exploded view of the melt system of FIG. 2A.

### DETAILED DESCRIPTION

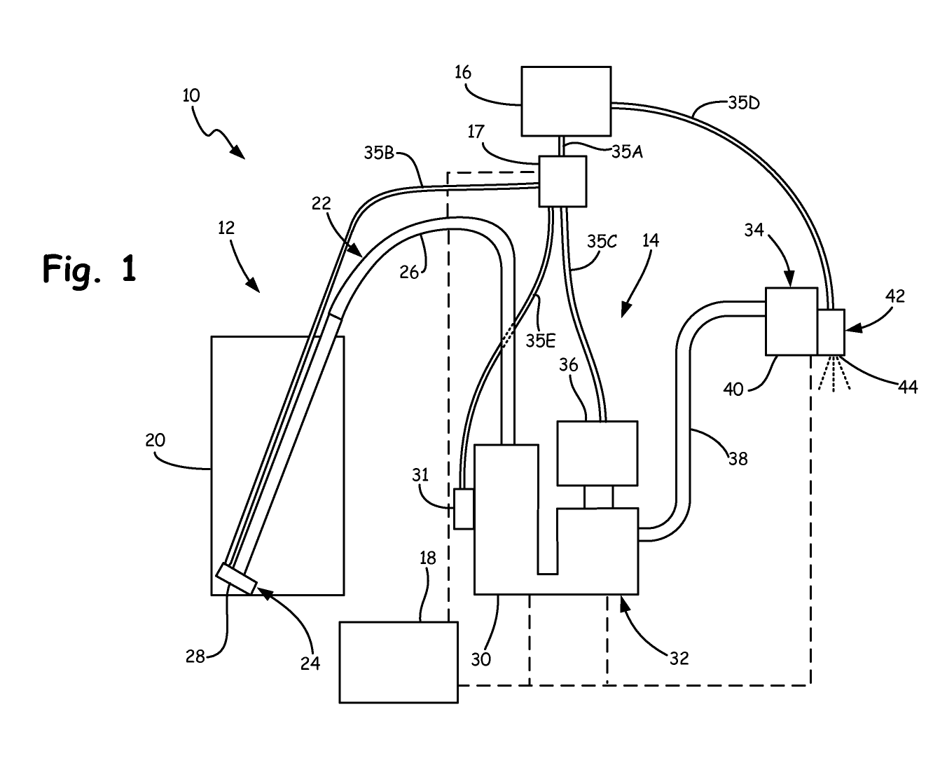

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, vibration generating device 31, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Air hose 35E connects air source 16 to vibration generating device 31 via air control valve 17. Controller 18 is connected in communication with various components of system 10, such as air control valve 17, melt system 30, pump 32, and/or dispenser 34, for controlling operation of system 10.

System 10 for dispensing hot melt adhesive is described in U.S. patent application Ser. No. 13/660,421, entitled “MELTER”, which is incorporated herein by reference. Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a tank and resistive heating elements for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time.

As will be discussed subsequently, vibration generating device 31 is mounted to the melt system 30 and is driven to vibrate one or more components of the melt system 30 to reduce the likelihood of liquid hot melt adhesive clinging to the walls of the melt system 30 and becoming char.

Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and dispensing module 42. Hot melt adhesive from pump 32 is received in manifold 40 and dispensed via dispensing module 42. Dispenser 34 can selectively discharge hot melt adhesive whereby the hot melt adhesive is sprayed out outlet 44 of dispensing module 42 onto an object, such as a package, a case, or another object benefiting from hot melt adhesive dispensed by system 10. Dispensing module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

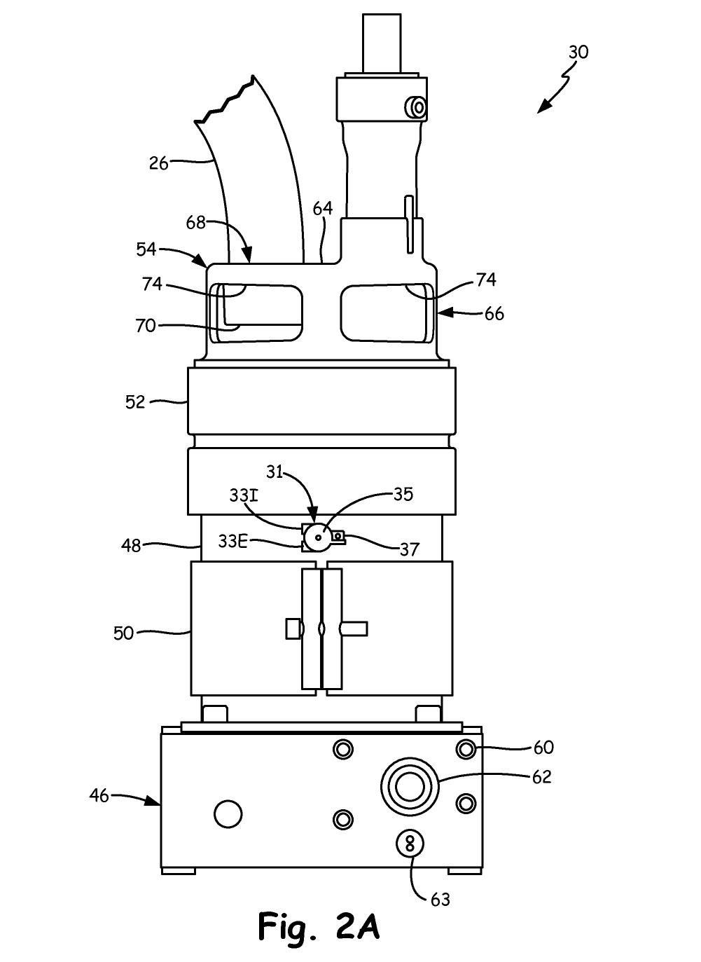

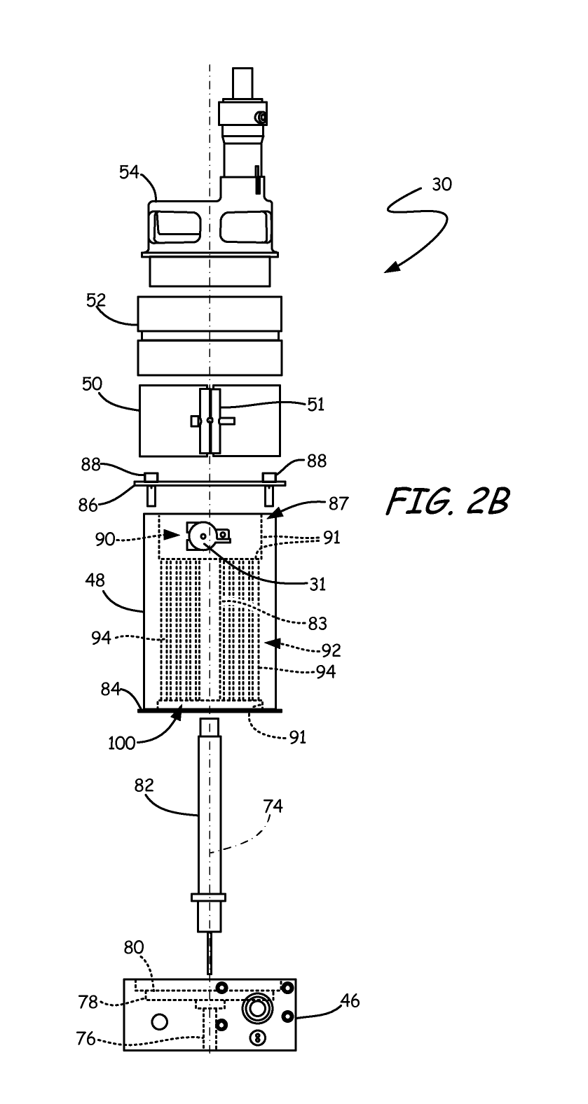

In FIG. 2A, a side view of melt system 30 is shown. In the illustrated embodiment, melt system 30 includes vibration generating device 31, base 46, melter 48, band heater 50, thermal break 52, and feed cap 54. Melter 48 is positioned on and supported by base 46. Vibration generating device 31 is mounted to melter 48 and is connected to control valve 17 (FIG. 1) via air hose 35E (FIG. 1). Base 46 includes bolt holes 60 for connecting base 46 to pump 32 (shown in FIG. 1).

Base 46 also includes base outlet 62 to allow fluid flow from melter 48 to pump 32. Band heater 50 is attached to melter 48 for heating melter 48, and base heater 63 is attached to base 46 for heating base 46. Base heater 63 is an electrically powered resistive heating element in a rod-form. Band heater 50 is an electrically powered resistive heating element wrapped circumferentially around and in contact with melter 48 for conducting heat from band heater 50 to melter 48. Melter 48 forms a tank or container for melting adhesive pellets into a liquid state, and for holding the adhesive pellets and the hot melt adhesive in the liquid state.

In the illustrated embodiment, melter 48 is substantially cylindrical. In alternative embodiments, melter 48 can have a different shape, such as oval, square, rectangular, or another shape suitable for the application. Similarly, although only one vibration generating device 31 is shown in the FIGURES, in other embodiments more than one vibration generating device can be used on different components of the melt system 30 (such as base 46) as criteria dictate.

Thermal break 52 is a connector that connects feed cap 54 to melter 48. Thermal break 52 can reduce heat conduction from relatively hot melter 48 to relatively cool feed cap 54. Thermal break 52 can be made of silicone or another material having a relatively low thermal conductivity. In alternative embodiments, thermal break 52 can be omitted and feed cap 54 can be connected to melter 48 either directly or via another suitable mechanism.

Feed cap 54 is a cover for melter 48 and melt system 30, and is connected to a top of melter 48. In one embodiment, feed cap 54 can be made of a polymer material. In alternative embodiments, feed cap 54 can be made of another material, such as a metal. Feed cap 54 includes cap top 64 and cap side 66. In the illustrated embodiment, cap side 66 is substantially cylindrical and cap top 64 has a substantially circular shape when viewed from above. Feed cap 54 can have a shape that is similar to that of melter 48, or can have a shape that differs from that of melter 48.

Feed inlet 68 is positioned on cap top 64 and includes inward projection 70, extending downward from cap top 64. Feed inlet 68 is a hole through cap top 64 and is connected to feed hose 26 for receiving a supply of adhesive pellets and air supplied by feed assembly 22 (shown in FIG. 1). Feed assembly 22 is a feed system for feeding the supply of adhesive pellets from container 20 (shown in FIG. 1). Feed hose 26 extends into inward projection 70 of feed inlet 68. Cap side 66 of feed cap 54 includes windows 74, which allow the air carrying the adhesive pellets to be vented to the atmosphere as the pellets fall from projection 70 into melter 48.

In FIG. 2A, vibration generating device 31 is illustrated as a pneumatically driven shaker that utilizes compressed air from air source 16 (FIG. 1). The air travels through air line 35E (FIG. 1) and through an inlet 331 in the housing 35 of the shaker into a cavity formed between circumferential raceways. The air exits the shaker at an exit 33E. Shaker can be affixed to melter 48 via a tab or flange 37 that receives a fastener. The compressed air causes a ball to roll along the circumference of raceways. The weight imbalance that results from the ball rolling along raceways induces vibration of shaker and melter 48. The vibration of melter 48 causes liquid adhesive to flow off the walls of the melter 48. In other embodiments, vibration generating device 31 can be driven by hydraulic, electrical, mechanical or other means. In one embodiment, shaker comprises a pneumatic vibrator such as model # BBS-130 manufactured by VIBCO of Wyoming, R.I. In another embodiment, vibration generating device 31 can comprise an ultrasonic shaker in one embodiment.

In FIG. 2B, an exploded view of melt system 30 is shown. More specifically, the components of melt system 30 have been separated along linear stacking axis 74. In general, melter 48, plate 86, and cartridge heater 82 are releasably attached to base 46; melter 48 and feed cap 54 are releasably attached to thermal break 52; and vibration generating device 31, band heater 50, and cartridge heater 82 are releasably attached to melter 48. In this sense, releasably attached denotes that two or more components are attachable and detachable without permanent physical modification to any component. Two non-limiting examples of releasably attached pieces include a component being pushed into an aperture of another component by hand and a component being fastened to another component using a threaded fastener.

Melt system 30 includes vibration generating device 31 mounted to the exterior of melter 48. As previously discussed, melter 48 comprises tank 87 for containing liquid adhesive. Walls 91 of tank 87 form the interior of melter 48, and define chamber 90, channels 94, and container 100.

Tank 87 includes chamber 90 at the upper end of the interior of melter 48. Chamber 90 is a cylindrical volume for receiving pellets. Below chamber 90 is divider 92 with walls (part of walls 91) that define a plurality of channels 94. Divider 92 is a solid cylindrical body that includes a plurality of circularly cylindrical channels 94. Each channel 94 is fluidly connected to chamber 90 and extends downwards through melter 48.

At the bottom end of channels 94 is collector 100. In the illustrated embodiment, collector 100 is formed by walls 91 and comprises a plain cylindrical volume that is positioned for receiving melt liquid from channels 94. In addition, collector 100 is a counterbore that surrounds and is coaxial with cartridge bore 83. Collector 100 is also fluidly connected to basin 78 of base 46 on the bottom side. Basin 78 is also a plain cylindrical volume, although outlet 62 is cut into the rear side of basin 78 so that basin 78 and outlet 62 are fluidly connected.

In the illustrated embodiment, stacking axis 74 begins at base 46 and extends upwards. Base 46 has a plurality of internal reliefs including heater bore 76, basin 78, and ledge 80. More specifically, heater bore 76 is a threaded aperture that passes through base 46 and is concentric with and extends along stacking axis 74. Above heater bore 76 is basin 78. Above basin 78 is ledge 80, which has a shallow, disc shape that is concentric with and extends along stacking axis 74. Heater bore 76 is for attaching cartridge heater 82 within base 46. Cartridge heater 82 is an electrically powered resistive heating element in a rod-form for heating melter 48, and, more specifically, cartridge heater 82 includes an aluminum thermal housing with an electric heater cartridge inside of the housing. Ledge 80 is for locating melter 48 within base 46. Specifically, rim 84 of melter 48 interfaces with ledge 80 when melter is adjacent to base 46.

To assemble the illustrated embodiment of melt system 30, cartridge heater 82 is moved toward base 46 along stacking axis 74 and is screwed into heater bore 76 until cartridge heater 82 is fully seated in base 46. Cartridge heater 82 is electrically connected to controller 18 (shown in FIG. 1) for operability purposes. Then melter 48 is moved down stacking axis 74, and cartridge heater 82 is inserted into cartridge bore 83. Melter 48 is moved further downward until rim 84 is seated in ledge 80 of base 46. Then plate 86, which has an aperture that is larger than melter 48, is placed over melter 48 and moved down stacking axis 74. Plate 86 is then fastened to base 46 with a plurality of bolts 88, capturing melter 48 between ledge 80 and plate 86. Melter 48 is held captive because the aperture in plate 86 is smaller than the outer diameter of rim 84. Then band heater 50 is placed around melter 48, secured with latch 51, and electrically connected to controller 18 (shown in FIG. 1). If the assembly process is stopped at this point, this is the degree of assembly of melt system 30.

To complete assembly of melt system 30, thermal break 52 is placed at the top of melter 48, and moved down stacking axis 74 until it is seated. Finally feed cap 54 is moved along stacking axis 74, seating feed cap 54 within thermal break 52.

The components and configuration of melt system 30 allow for melter 48 to be releasably attached to base 46, band heater 50, and cartridge heater 82. This permits melter 48 to be exchanged if melter 48 needs cleaning or if system 10 (shown in FIG. 1) needs to be changed to run a different adhesive material. When such an exchange of melter 48 occurs, any remaining adhesive in melter 48 can be conserved for later use. In addition, vibration generating device 31, band heater 50, and cartridge heater 82 are releasably attached (for example by simple fasteners in the case of vibration generating device 31) to base 46 and/or melter 48. This permits the replacement of vibration generating device 31, band heater 50, and cartridge heater 82 in case of a failure of either of these components.

Depicted in FIG. 2B is one embodiment of the present invention, to which there are alternative embodiments. For example, not all of the components of melt system 30 need to be or have features that are concentric with stacking axis 74. For another example, melter 48 can be attached to base 46 using alternative components and features, such as an external thread on melter 48 and an internal thread in base 46. For a further example, melt system 30 can have at least two vibration generating devices 31 connected to base 46 and melter 48, respectively, with each vibration generating device 31 having its own air source. Such an arrangement of vibration generating devices 31 would allow for selective use of one device or both devices as operational criteria dictate. For yet another example, melt system 30 can have at least two melters 48 stacked atop one another each with one or more vibration generating devices 31. Only one melter 48 would be attached to base 46 and only one melter 48 would be attached to feed cap 54. In such a serial arrangement, the total volume of melted adhesive material is increased, allowing for short bursts of a very high, non-sustainable output rate (provided that there is an adequate recovery time with a low output rate).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A melter for a melt system comprising:
a tank having a wall for containing a hot melt adhesive;
a vibration generating device for vibrating the wall; and
a heater for transferring heat to the tank.

2. The melter of claim 1, wherein the tank has a thermally conductive body that is disposed within an interior of the tank.

3. The melter of claim 2, wherein the tank has a chamber disposed above an upper end of the body for receiving hot melt pellets.

4. The melter of claim 3, wherein the tank has a collector located below the chamber for receiving a liquid hot melt.

5. The melter of claim 4, wherein the wall defines an interior surface of the tank, and wherein the interior surface includes a plurality of channels that extend between the chamber and the collector.

6. The melter of claim 1, wherein the vibration generating device comprises a pneumatically driven shaker that is mounted to an exterior surface of the tank.

7. The melter of claim 6, wherein the pneumatically driven shaker is affixed to the tank by fasteners.

8. The melter of claim 1, wherein:
the tank has a chamber at an upper end thereof for receiving solid adhesive pellets and a collector located below the chamber for receiving a liquid adhesive as a result of melting of the solid adhesive pellets; and
the vibration generating device is mounted to an exterior of the tank and acts to vibrate the tank.

9. The melt system of claim 8, wherein the tank has a plurality of channels that extend between the chamber and the collector, wherein a plurality of walls of the plurality of channels form heat exchange surfaces.

10. The melt system of claim 9, wherein each of the plurality of channels is substantially circularly cylindrical.

11. The melt system of claim 8, wherein the vibration generating device comprises a pneumatically driven shaker.

12. A hot melt dispensing system comprising:
a hopper for storing hot melt pellets;
a melter capable of heating hot melt pellets into a liquid, the melter defining a tank for containing the hot melt pellets and the liquid;
a vibration generating device for vibrating the melter;
a feed system for transporting hot melt pellets from the hopper to the melter; and
a dispenser for administering the liquid from the melter.

13. The hot melt dispensing system of claim 12, wherein the tank includes:
a chamber for receiving the pellets;
a divider defining one or more channels that communicate with the chamber at a first end; and
a collector disposed below the divider and fluidly connected to the plurality of channels at a second end thereof.

14. The hot melt dispensing system of claim 12, wherein the vibration generating device comprises a pneumatically driven shaker that is mounted to an exterior surface of the melter.

15. A method of melting hot melt pellets into a liquid, the method comprising:
delivering hot melt pellets into a tank of a melter;
heating the melter to liquefy the pellets into a melt liquid; and
vibrating the tank.

16. The method of claim 15, further comprising:
flowing the melt liquid through a plurality of channels in the melter; and
collecting the melt liquid in a collector along a lower portion of the tank.

17. The method of claim 16, and further comprising:
drawing the melt liquid from the collector into a pump.

18. The method of claim 16, wherein the flowing the melt liquid comprises:
flowing the melt liquid in an interior of tank through a plurality of channels, wherein the plurality of channels are defined by walls that act as heat exchange surfaces.

19. The method of claim 15, wherein the vibrating of the tank induces flow of the melt liquid on an interior surface of the melter.

20. The method of claim 15, wherein heating the melter comprises:
transferring heat to the melter with an interior heater and an exterior heater.

21. The method of claim 15, wherein the vibrating of the tank comprises:
delivering a stream of compressed air to one or more pneumatically driven shakers that are mounted to an exterior surface of the melter.
